(19) United States
(12) Patent Application Publication
(10) Pub. No.: US 2003/0223450 A1
(43) Pub. Date: Dec. 4, 2003

(54) Aggregating multiple air interfaces with a multi-link protocol

(76) Inventors: Paul E. Bender, San Diego, CA (US); Ramin Rezaiifar, San Diego, CA (US)

Correspondence Address: Qualcomm Incorporated, Patents Department, 5775 Morehouse Drive, San Diego, CA, 92121-1714, US

(21) Appl. No.: 10/158,257

(22) Filed: May 29, 2002

(51) Int. Cl. H04B 7/216

(52) U.S. Cl. 370/441

(57) ABSTRACT

Techniques for aggregating multiple air interfaces to achieve higher data rates using standard link interfaces and a single user identifier are disclosed. In one aspect, each of a plurality of radio elements is associated with a unique link identifier and a common subscriber identifier. In another aspect, a base station authenticates a radio element by comparing a transmitted link identifier with a list of link identifiers accessed from a subscriber database indexed by subscriber identifier. In yet another aspect, a wireless connection is linked with an access node through an interface distinguished by the link identifier. The connection can be merged with other connections in a multi-link protocol. These aspects have benefits including allowing multiple devices to be supported with one subscriber identifier, achieving higher data rates due to aggregation of multiple links using standard interfaces, a single record per subscriber, and others.

### FIELD

The present invention relates generally to communications, and more specifically to a novel and improved method and apparatus for aggregating multiple air interfaces with a multi-link protocol.

### BACKGROUND

Wireless communication systems are widely deployed to provide various types of communication such as voice and data. These systems may be based on code division multiple access (CDMA), time division multiple access (TDMA), or some other modulation techniques. A CDMA system provides certain advantages over other types of systems, including increased system capacity.

A CDMA system may be designed to support one or more CDMA standards such as (1) the “TIA/EIA-95-B Mobile Station-Base Station Compatibility Standard for Dual-Mode Wideband Spread Spectrum Cellular System” (the IS-95 standard), (2) the standard offered by a consortium named “3rd Generation Partnership Project” (3GPP) and embodied in a set of documents including Document Nos. 3G TS 25.211, 3G TS 25.212, 3G TS 25.213, and 3G TS 25.214 (the W-CDMA standard), (3) the standard offered by a consortium named “3rd Generation Partnership Project 2” (3GPP2) and embodied in a set of documents including “C.S0002-A Physical Layer Standard for cdma2000 Spread Spectrum Systems,” the “C.S0005-A Upper Layer (Layer 3) Signaling Standard for cdma2000 Spread Spectrum Systems,” and the “C.S0024 cdma2000 High Rate Packet Data Air Interface Specification” (the cdma2000 standard), (4) the “TIA/EIA-IS-856 CDMA2000 High Rate Packet Data Air Interface Specification” (the IS-856 standard), and (5) some other standards. These and other wireless communication standards support data communication at various data rates.

Data communication can be supported wirelessly between a user and a network, such as the Internet. A data link may be comprised of an air interface connection between a wireless access terminal, such as a mobile station, and a base station, as well as an interface connection between the base station and a Packet Data Service Node (PDSN). An example of a PDSN is specified in “cdma2000 Wireless IP Network Standard” identified as the TIA/EIA/IS-835 standard. Examples of air interfaces include the standards listed above. A link between a base station and a PDSN can be established using an interface referred to as an A10/A11 interface, such as described in the “3GPP2 A.S0007, Inter-Operability Specification (IOS) for High Rate Packet Data (HRPD) Access Network Interfaces.” The A10 interface carries traffic between a Packet Control Function (PCF) node and a PDSN. The A10 interface provides a path for user traffic for packet data services. The A11 interface carries signaling information between the PCF and PDSN. Once these connections making up the link are established, data can flow between applications connected with or residing on the access terminal and applications connected to the PDSN. Note that the mobile station includes radio elements identified as e1 and e2, wherein each radio element includes a separate protocol stack as specified in IS-856.

The maximum throughput on the link may be dictated by the slowest connection in the link, which may be the air interface. The data throughput or data rate can be increased by establishing more than one link between the access terminal and the access network, and using the multiple links to transmit data between applications. A multi-link protocol can be deployed to facilitate dividing the data into various links on the transmission side and recombining, or aggregating, the data on the receiving side. One multi-link protocol, for use with the Point-to-Point Protocol (PPP), is described in “The PPP Multilink Protocol (MP)”, IETF RFC 1990.

Wireless links can be established by accessing an Authentication, Authorization, and Accounting (AAA) server. An AAA server maintains account information for network users. The information for a user can be indexed according to a user identifier, an example of which is the Network Access Identifier (NAI), as described in “The Network Access Identifier”, by B. Aboba et al., published January 1999 and identified as IETF RFC 2486. The information may include key (or password) information for authenticating/authorizing a subscriber, a mobile station identifier associated with the account, and usage information for billing.

Establishing multiple air interface connections for one user may require multiple accounts or subscription records for that user to be maintained in the AAA server, as well as associated keys, and multiple billing records (if applicable). To minimize system complexity, it is desirable to maintain a single database for each user, while allowing the higher data rates afforded through aggregating multiple air interfaces with a multi-link protocol. Meanwhile, various interface standards are defined and accepted which can be used for setting up links within a multi-link session. There is, therefore, a need in the art for aggregating multiple air interfaces to achieve higher data rates using standard link interfaces and a single user identifier.

### SUMMARY

Embodiments disclosed herein address the need for aggregating multiple air interfaces to achieve higher data rates using standard link interfaces and a single user identifier. In one aspect, each of a plurality of radio elements is associated with a unique link identifier and a common subscriber identifier. In another aspect, a base station authenticates a radio element by comparing a transmitted link identifier with a list of link identifiers accessed from a subscriber database indexed by subscriber identifier. In yet another aspect, a wireless connection is linked with an access node through an interface distinguished by the link identifier. The connection can be merged with other connections in a multi-link protocol. These aspects have benefits including allowing multiple devices to be supported with one subscriber identifier, achieving higher data rates due to aggregation of multiple links using standard interfaces, a single record per subscriber, and others.

The invention provides methods and system elements that implement various aspects, embodiments, and features of the invention, as described in further detail below.

### BRIEF DESCRIPTION OF THE DRAWINGS

The features, nature, and advantages of the present invention will become more apparent from the detailed description set forth below when taken in conjunction with the drawings in which like reference characters identify correspondingly throughout and wherein:

FIG. 1 is a general block diagram of a wireless communication system capable of supporting a number of users;

FIG. 2 depicts a portion of a mobile station equipped for multi-link communication;

FIG. 3 depicts a portion of a base station equipped for multi-link communication;

FIG. 4 depicts a portion of an Authentication, Authorization, and Accounting (AAA) server;

FIG. 5 depicts a multi-link communication session;

FIG. 6 depicts a flowchart of an embodiment of a method for aggregating multiple air interfaces with a multi-link protocol; and

FIG. 7 depicts a flow diagram for one embodiment of providing multiple interfaces.

### DETAILED DESCRIPTION

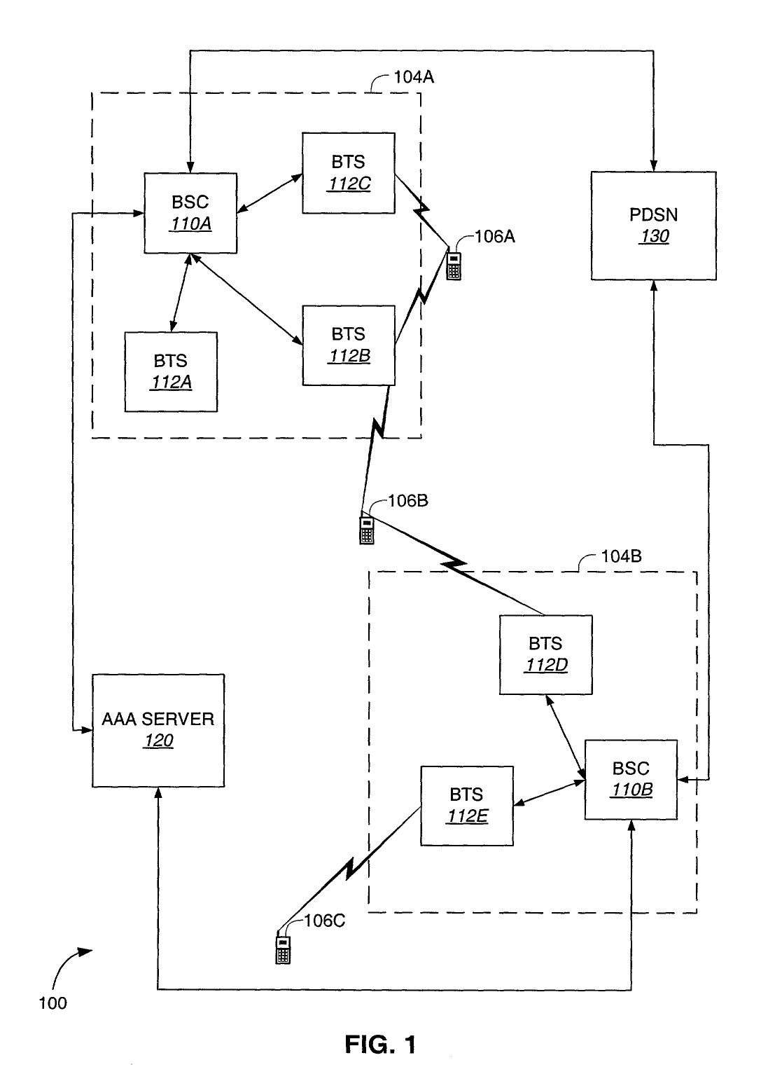

FIG. 1 is a diagram of a wireless communication system 100 that may be designed to support one or more CDMA standards and/or designs (e.g., the W-CDMA standard, the IS-95 standard, the cdma2000 standard, the IS-856 standard). For simplicity, system 100 is shown to include two base stations 104 in communication with three mobile stations 106. The base station and its coverage area are often collectively referred to as a “cell”. In IS-95 systems, a cell may include one or more sectors. In the W-CDMA specification, each sector of a base station and the sector's coverage area is referred to as a cell. As used herein, the term base station can be used interchangeably with the terms access point or NodeB. The term mobile station can be used interchangeably with the terms user equipment (UE), subscriber unit, subscriber station, access terminal, remote terminal, or other corresponding terms known in the art. The term mobile station encompasses fixed wireless applications.

Depending on the CDMA system being implemented, each mobile station 106 may communicate with one (or possibly more) base stations 104 on the forward link at any given moment, and may communicate with one or more base stations on the reverse link depending on whether or not the mobile station is in soft handoff. The forward link (i.e., downlink) refers to transmission from the base station to the mobile station, and the reverse link (i.e., uplink) refers to transmission from the mobile station to the base station.

For clarity, the examples used in describing this invention may assume base stations as the originator of signals and mobile stations as receivers and acquirers of those signals, i.e. signals on the forward link. Those skilled in the art will understand that mobile stations as well as base stations can be equipped to transmit data as described herein and the aspects of the present invention apply in those situations as well. The word “exemplary” is used exclusively herein to mean “serving as an example, instance, or illustration.” Any embodiment described herein as “exemplary” is not necessarily to be construed as preferred or advantageous over other embodiments.

Each base station 104 comprises a Base Station Controller (BSC) 110 communicating with one or more Base-station Transceiver Subsystems (BTS) 112. A mobile station 106 communicates with one or more BSCs 110 via a wireless connection with one or more BTSs 112. In this example, BSC 110A is connected with BTS 112A, 112B, and 112C. BSC 110B is connected with BTS 112D and 112E. Mobile station 106A is communicating to BSC 110A via wireless connections with BTS 112B and 112C. Mobile station 106B communicates with BSC 110 through BTS 112B, and with BSC 110B through BTS 112D. Mobile station 106C communicates with BSC 110B via BTS 112E.

Data connections for mobile stations 106 are set up through one or more BSCs 110 through an interface to PDSN 130. (Multiple PDSNs 130 may be deployed.) The various wireless connections shown in FIG. 1 may be used for employing soft handoff. In addition, multiple data links can be set up for aggregation with a Multi-link Protocol (MP) in PDSN 130. (A multi-link protocol to aggregate links from multiple PDSNs 130 is contemplated as well, details not shown.) Exemplary wireless communication devices and multi-link aggregation methods suitable for deployment in communication system 100 will be detailed further below.

Wireless connections between various base stations 104 and mobile stations 106 are established using AAA server 120. AAA server 120 is used for authentication and authorization of a mobile station 106, by verifying that the mobile station identification corresponds to a valid subscriber. The subscriber is authenticated using an authentication protocol with a shared secret, password, or key corresponding to the subscriber information stored in AAA server 120. A variety of authentication protocols are known in the art, and any such scheme can be deployed within the scope of the present invention. In the exemplary embodiment, the Challenge Handshake Authentication Protocol (CHAP) is deployed for authorizing and authenticating subscribers within the Radio Access Network (RAN). In addition, AAA server 120 can be used to collect network usage information for use in various services, such as billing. AAA server 120 communicates with the BSC 110 within a base station 104 using one of the various schemes for AAA server/BSC communication known in the art. Examples include RADIUS and DIAMETER. In the exemplary embodiment, RADIUS is used, as defined in “Remote Authentication Dial In User Service (RADIUS)”, IETF RFC 2865. Any means for communicating between AAA server 120 and BSC 110 can be deployed within the scope of the present invention.

Although a single AAA server 120 is shown, those of skill in the art will recognize that AAA server 120 may represent a network of AAA servers and/or proxy AAA servers. An AAA server 120 in one network may receive a request for authentication of a mobile station, whose user identifier is not known by that AAA server. The AAA server may access one or more additional servers with the request, until the AAA server containing the information corresponding to the user identifier is found. In the exemplary embodiment, the user identifier is a Network Access Identifier (NAI), which contains an address that is a concatenation of a user identifier and a realm identifier, given by user@ realm. If information for the realm is not contained in the AAA server 120, then another AAA server, perhaps through a proxy server, is accessed with that realm information.

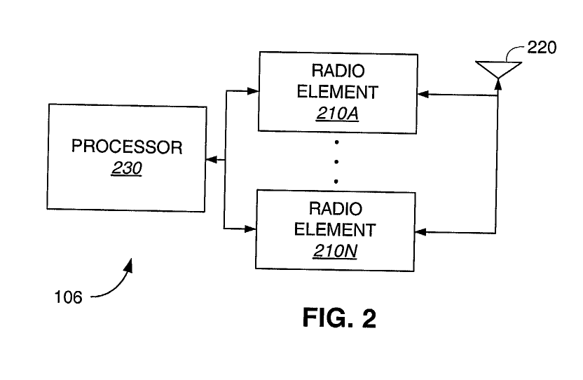

FIG. 2 depicts a portion of mobile station 106, configured for aggregating multiple air interfaces. Radio elements 210A-210N are connected to antenna 220 for communicating with one or more base stations 104. Each radio element can establish a wireless connection with one or more BTSs 112, and thereby communicate with one or more BSCs 110. In the exemplary embodiment, each radio element includes a separate protocol stack as specified in IS-856. Various techniques for deploying radio elements are known in the art, and new radio elements are contemplated. The radio elements 210A-210N are connected to processor 230, which comprises a multi-link protocol, such as Multi-link PPP, for aggregating the data from radio elements 210A-210N. Each radio element 210 has an identifier associated with it. Various means for assigning identifiers to the radio elements can be deployed. In the exemplary embodiment, the radio element identifier is the International Mobile Subscriber Identification (IMSI). The radio element identifier can be associated with the link incorporating the wireless connection established by the radio element 210.

In establishing the wireless portion of a link, a user identifier corresponding to mobile station 106 is transmitted along with the radio element identifier. (The user identifier can be a subscriber identifier, as described herein.) In the exemplary embodiment, the user identification is an NAI. Thus, in connecting a radio element 210 with a BTS 112, an NAI (user@ realm) will be transmitted along with an IMSI to establish the wireless communication session. The NAI will be used to identify the user, whose data application may be communicating with an aggregation of multiple air interfaces. Each air interface will be part of a link between the mobile station 106 and, ultimately, PDSN 130. Each link will correspond to the IMSI of one radio element 210. The multi-link protocol running on processor 230 may use an end-point discriminator to associate each link with an aggregate bundle, as specified in “The PPP MultiLink Protocol (MP)” by K. Sklower et al., published August 1996 and identified as IETF RFC 1990.

Processor 230 may be a general purpose microprocessor, a digital signal processor (DSP), or a special purpose processor. Processor 230 may perform some or all of the functions of radio elements 210A-210N, and may be connected with special purpose hardware to assist in these tasks. The multi-link protocol running on processor 230 communicates with one or more data applications, delivering data for transmission across radio elements 210A-210N and aggregating data received therefrom for use in the data applications. Data applications may be external to mobile station 106, such as an externally connected laptop computer, may run on an additional processor within mobile station 210 (not shown), or may run on processor 230 itself. Processor 230 may have embedded memory, or be connected to a memory (not shown) for storing instructions to carry out various methods for aggregating multiple air interfaces, detailed further below.

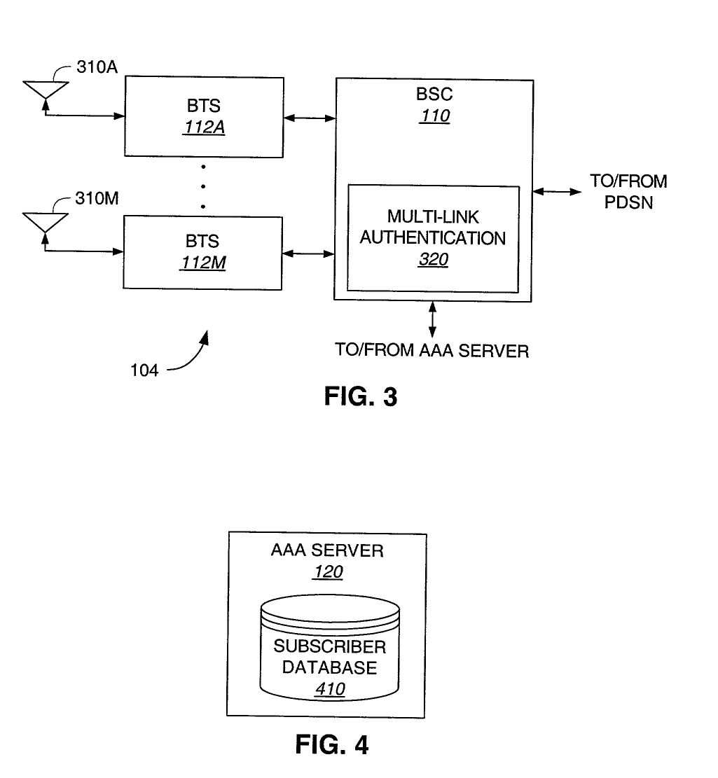

FIG. 3 depicts a portion of base station 104, configured for facilitating multiple air interface aggregation. BSC 110 communicates with BTS 112A-BTS 112M. As discussed above with respect to FIG. 1, each BTS 112 can establish one or more wireless communication session with a radio element 210 in a mobile station 106. BTS 112A-BTS 112M communicate with mobile stations via antennas 310A-310M, respectively. Furthermore, as discussed above with respect to FIG. 1, a mobile station 106 may establish a wireless communication session with more than one BTS 112, which in turn can communicate with one or more BSC 110. (Additional BSCs 110 would commonly be deployed in additional base stations 104.) Each of the multiple wireless communication sessions associated with a single mobile station 106 can be distinguished by the corresponding radio element identifier.

BSC 110 communicates with PDSN 130 by setting up various links corresponding to the wireless communication sessions just described. Any BSC to PDSN interface can be deployed. These links are referred to herein as R-P interfaces. In the exemplary embodiment, each R-P interface is an A10/A11 interface established corresponding to a link associated with a radio element identifier, or link identifier, and also corresponding to a wireless communication session (or air interface).

BSC 110 communicates with AAA server 120 to authenticate a wireless communication session with radio elements 210 in a mobile stations 106. Multi-link authentication block 320 can be deployed within BSC 110 to facilitate authorization and authentication of the communication session in conjunction with AAA server 120 and to provide accounting information, such as network usage, to AAA server 120, when applicable. The functions of multi-link authentication block, in the exemplary embodiment, are integrated with other processing tasks and carried out in one or more general purpose processors within BSC 110 (details not shown). The interaction between BSC 110, PDSN 130, and AAA server 120 will be detailed further below.

FIG. 4 depicts a portion of an AAA server 120. AAA server 120 contains a subscriber database 410, which contains a list of subscribers and associated records containing information for the respective subscribers. In addition to various subscriber parameters, such as shared secret or key information for authentication, service level requirements, and the like, each record contains one or more radio element identifiers associated with the subscriber. In the exemplary embodiment, the subscribers are indexed according to NAI, and each NAI that supports multi-link communication will have one or more IMSIs associated with it. The radio element identifiers contained in a record for a subscriber may identify radio elements in a single communication device, such as the mobile station 106 described above with respect to FIG. 2. Furthermore, the exemplary AAA server can support multiple communication devices associated with a single subscriber by associating the radio element identifiers for each communication device with the subscriber. One or more of the multiple communication devices supported in a single AAA server 120 subscriber record may be multi-link devices, whose radio elements are identified in the record.

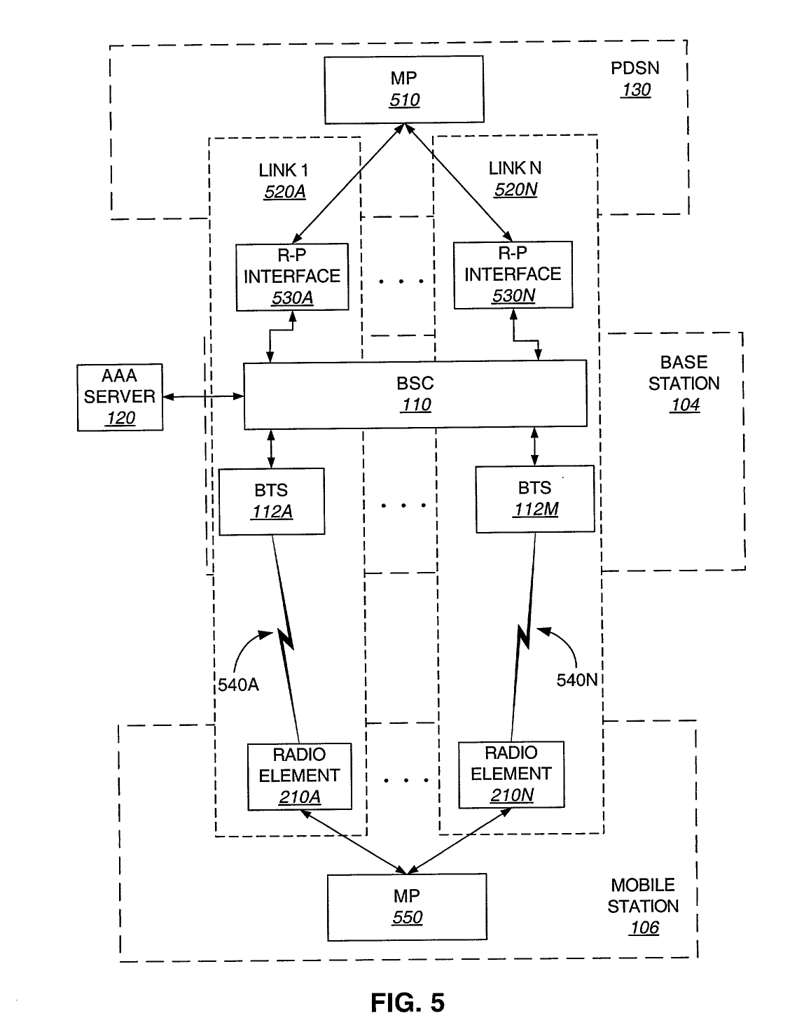

FIG. 5 depicts a multiple link communication session. Multi-link Protocol (MP) 510 within PDSN 130 communicates with MP 550 within mobile station 106 through multiple links, Link1-Link N, 520A-520N, respectively. Each link comprises an air interface, or wireless communication link, 540A-540N, established between radio elements 210A-210N, respectively, and one or more BTSs, 112A-112M, respectively. The multiple radio elements 210A-210N communicate with MP 550, which sinks data to and sources data from a data application (not shown). As described above, one BTS can be used to form more than one wireless communication link with radio elements 210A-210N. The N wireless communication links 540A-540N are connected to BSC 110 through BTSs 112A-112M. As described above, more than one BSC 110 can be deployed, but only one is shown in FIG. 5, for clarity. BSC 110 authorizes and authenticates the wireless communication links 540A-540N with AAA server 120. After the wireless communication links 540A-540N are established, links 520A-520N can be completed by establishing N R-P interfaces 530A-530N between BSC 110 and PDSN 130. R-P interfaces 530A-530N communicate with MP 510 in PDSN 130, which sinks data to and sources data from a data application, or an external network such as the Internet (not shown).

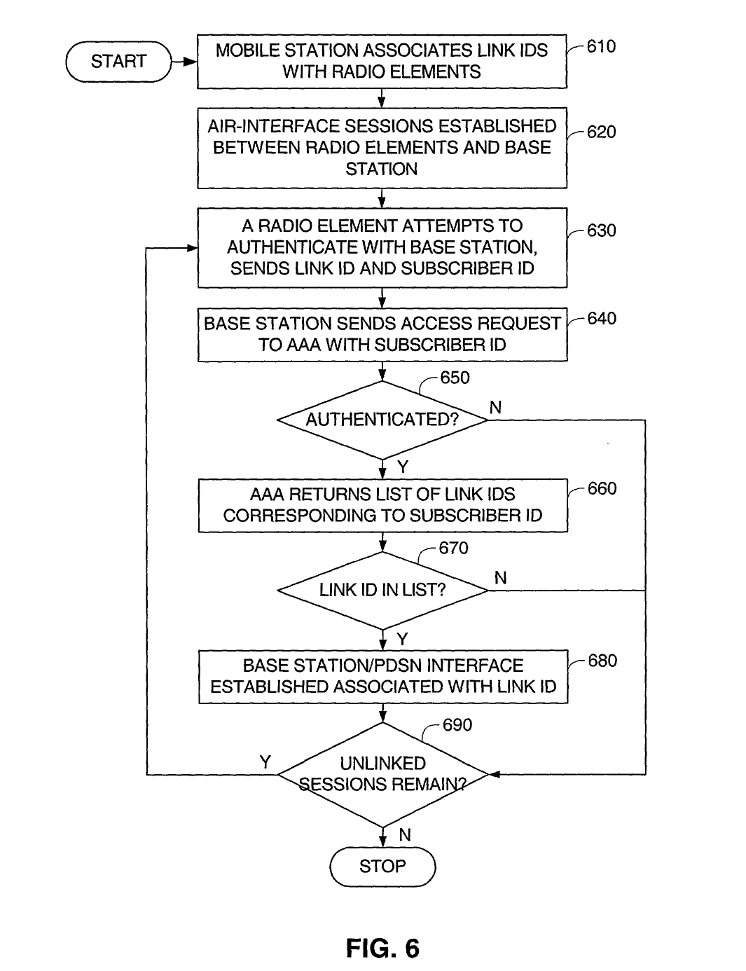

FIG. 6 is a flowchart depicting steps to establish a multi-link communication session, such as the one described above with respect to FIG. 5. The process begins in step 610, where the access terminal (e.g. mobile station) 106 associates link identifiers with each of the radio elements 210A-210N. In the exemplary embodiment, the multi-link protocol is multi-link PPP, and the link identifier associated with each radio element is that element's IMSI. Proceed to step 620.

In step 620, an air interface session (or wireless communication session) is established between each of the radio elements 210A-210N and the base station 104. These air interface sessions may be established with one or more BTSs 112A-112M. Note that all the air interface sessions need not be established at the same time. Additional sessions can be added subsequent to the completion of the process shown in FIG. 6, with that process repeated for the additional sessions. In the exemplary embodiment, the air interface sessions conform to the IS-856 standard. Alternative embodiments can employ any air interface standard, including other CDMA and non-CDMA wireless standards. Proceed to step 630. Furthermore, each air interface session can conform to a different air interface standard.

In step 630, in order to complete the establishment of the air interface session, each radio element is authenticated. The process described in steps 630-690 will be repeated until the wireless communication session associated with each radio element has been processed. In step 630, one of the radio elements sends its link identifier and the subscriber identifier, which is common to all the radio elements, to the base station for authentication. In the exemplary embodiment, the subscriber identifier is a Network Address Identifier (NAI), as described above. The authentication protocol is the Challenge Handshake Authentication Protocol (CHAP), as described above. In alternative embodiments, any authentication protocol can be deployed. One object of authentication is for the radio element to prove it is the radio element it claims to be. In the exemplary embodiment, one aspect of authentication is that the base station confirms that the radio element is the true owner of the IMSI that it provides to the base station after successful authentication. The base station establishes authenticity of the radio element by reception of an Access-Accept (or its equivalent if RADIUS is not used) from the AAA server. Proceed to step 640.

In step 640,The base station authenticates the radio elements by consulting with the AAA server 120, which stores shared secret or key information for each subscriber, as described above. The base station 104 sends an access request to the AAA server 120 with the subscriber identifier. In the exemplary embodiment, the base station communicates with the AAA server using RADIUS packets, defined in IETF RFC 2865. Each radio element corresponding to an access terminal or mobile station 106 will provide a common NAI when challenged by the base station. Proceed to decision block 650.

In decision block 650, if the radio element is authenticated, proceed to step 660. If not, proceed to decision block 690 to test if additional sessions remain. In step 660, the AAA server accesses the record corresponding to the subscriber identifier and returns a list of link identifiers associated with it (other information from the record may also be returned). Note that steps 640 and 660 may occur simultaneously with 630, as part of the authentication procedure. Proceed to decision block 670.

In decision block 670, if the link identifier provided by the radio element is among those associated with the subscriber identifier (provided by the AAA in step 660), then the base station can proceed to complete the link with the PDSN. In this case, proceed to step 680. If the radio element identifier is not in the list, abort this session and proceed to step 690 to attempt to link another session. In one embodiment, multi-link authentication block 320, shown in FIG. 3, is used to authenticate wireless communication sessions associated with multiple link identifiers corresponding to one subscriber identifier.

In step 680, the base station 104 will establish with the PDSN 130 an interface associated with the link identifier. This link is referred to above as an R-P link. In the exemplary embodiment, the R-P interface is an A10/A11 interface, with the Mobile Node ID (MNID) set to the IMSI of the radio element. At this point, a link 520 has been established between a radio element 210 and PDSN 130. The link may be connected with multi-link protocol 550 in mobile station 106. The link can also be merged with any existing links 520 already merged using multi-link protocol 510 in the PDSN, or access node. In the exemplary embodiment, this step is accomplished by the radio element 210 sending a Link Control Protocol (LCP) option—the Endpoint Discriminator Option—specifying the same <class, address> pair as the <class, address> pair of the links already merged with MP 510. Reference IETF RFC 1990 for details. Also see “The Point-to-Point Protocol (PPP)”, IETF RFC 1661.

Note that the timing of step 610 (associating radio elements/links with the terminal multi-link protocol 550) does not have to match FIG. 6 precisely. Once multiple links 520 are formed, and merged, then the multi-link session should be complete between MP 550 and MP 510. At this point, data can flow over the virtual link between the two MPs, 510 and 550, at the aggregate data rate corresponding to the sum of the data rates of the underlying links 520.

Proceed to decision block 690, to test for sessions 540 remaining to be linked. If another session remains, return to step 630. Once all the sessions are linked, the process stops. It should be noted that in all the embodiments described above, method steps can be interchanged without departing from the scope of the invention.

For clarity of discussion, the foregoing has been described in terms of a single mobile station 106 and a single base station 104. Multiple base stations 104, or base station controllers 110, can be deployed within a single multi-link communication session. Furthermore, the radio elements 210 were discussed in context of residing on a single mobile station or access terminal 106. The principles discussed herein translate readily to radio elements residing on multiple mobile stations 106. As long as the multi-link protocol 550 can connect with the various links 520 created, the physical paths of those links 520 are not restricted. All of these conceivable scenarios are supported due to the AAA server 120 maintaining a list of multiple link identifiers associated with a subscriber identifier. By returning the entire list upon an access request, as in step 640, described above, the AAA server 120 and requesting base station 104 need not be aware of whether any other links 520 are formed or forming. Neither is the physical location of the other links 520 required to establish a new link (the other link may exist between a completely separate base station and mobile station). The existence of the current link identifier within the list returned form AAA server 120 is sufficient to setup a new link 520. The new link 520 can be merged with a multi-link protocol 510, and the multi-link communication session can then proceed enjoying the additional capacity of the new link.

Note also that the procedure described above for authenticating multiple radio elements using a single user identifier can also be used whether or not multiple air interfaces are aggregated. For example, a subscriber may own multiple wireless communication devices, e.g. a handheld phone, a laptop with wireless modem, and an on-board communication system in an automobile. AAA server 120, described in FIG. 4, can be used to allow the subscriber to establish wireless communication sessions with any or all of the subscriber's multiple devices, while maintaining only a single subscriber account and allowing all the applicable usage and/or billing information to be collected in one record. This feature is useful in both the multi-link protocol context as well as the multiple device context just described.

Note further that in the exemplary embodiment, standard interfaces were employed for establishing links 520. As an example, IS-856 wireless links connect radio elements 210 with BTSs 112. A BTS 112 need not be aware that a radio element is part of a multi-link communication session. As another example, a standard A10/A11 interface 530 connects a BSC 110 with a PDSN 130. Neither of these standardized links which are components of a link 520 need to be modified in any way in deployment of the exemplary embodiment. Furthermore, links 520 appear to multi-link protocols 510 and 550 as any other PPP links, and can be merged according to standardized procedures.

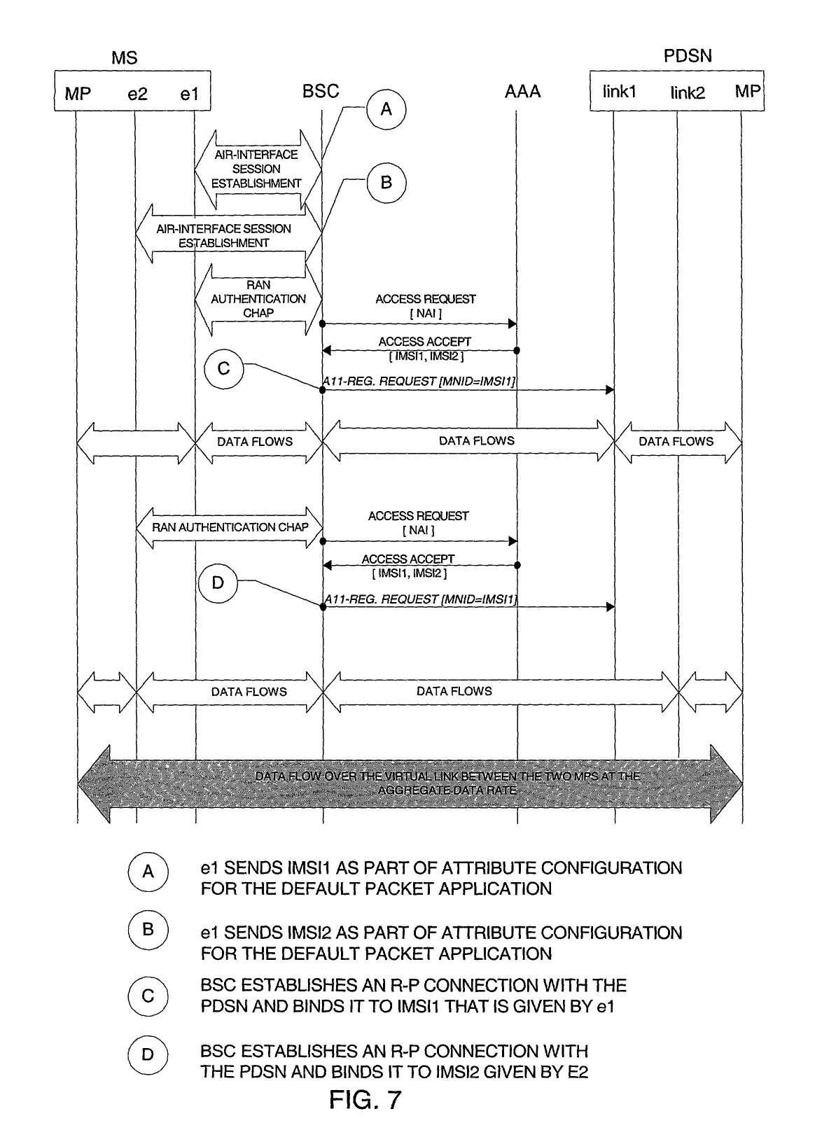

FIG. 7 illustrates a simplified flow diagram for one embodiment. As illustrated: both e1 and e2 establish an IS-856 type session that binds a Packet Application to one of the streams. The e1 indicates that IMSI1 is to be associated with the A11 interface. The e2 indicates that IMSi2 is to be associated with the A11 interface. The BSC authenticates the e1 and e2 by consulting with the AAA server (Access-Request and Access-Accept are RADIUS packets defined in RFC2865). Both e1 and e2 provide the same NAI (RFC 2498) when challenged by the BSC. The AAA server has a single record associated with this particular NAI. Both IMSi1 and IMSi2 are bound to this NAI. Therefore, the AAA server database has a single entry for each MS, in comparison to two entries; one for e1 and one for e2. After the BSC successfully authenticates both e1 and e2, then it may proceed to establish two A10/A11 interfaces to the PDSN: one for e1; and one for e2. In an alternate embodiment, BTS1 and BTS2 are attached to different BSCs but the flow remains basically the same. The e1 establishes the first link (link1). The e2 establishes the second link (link2). The e2 indicates that it wants link2 to be “merged” with link1 through multi-link PPP, which may be implemented according to RFC 1990 by e2 sending an LCP option (Endpoint Discriminator Option) specifying the same <class, address> pair as the <class, address> pair associated with link1.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of communication between an access terminal, including a plurality of radio elements, and an access node, including a multi-link protocol, comprising:
sending a link identifier and subscriber identifier from each of the plurality of radio elements to a base station, each link identifier unique to a corresponding radio element and the subscriber identifier common to the plurality of radio elements.

2. The method of claim 1, further comprising accessing a subscriber database with the subscriber identifier to receive a link identifier list comprising one or more link identifiers associated with the subscriber identifier.

3. The method of claim 2, further comprising authenticating a wireless connection between the base station and one of the plurality of radio elements when the link identifier associated with the radio element matches a link identifier in the link identifier list.

4. The method of claim 3, further comprising connecting the wireless connection to the access node, the connection distinguished by the link identifier.

5. The method of claim 4, further comprising merging the connection with existing connections using the multi-link protocol and aggregating data therefrom.

6. A method of authentication, comprising:
receiving a link identifier and a subscriber identifier from a radio element;
receiving a link identifier list corresponding to the subscriber identifier from a subscriber database; and
authenticating the radio element when the link identifier matches a link identifier in the link identifier list.

7. Processor readable media operable to perform the following steps:
receiving a link identifier and a subscriber identifier from a radio element;
receiving a link identifier list corresponding to the subscriber identifier from a subscriber database; and
authenticating the radio element when the link identifier matches a link identifier in the link identifier list.

8. A communication system, including a base station operable with a plurality of radio elements and a subscriber database, the subscriber database including lists of link identifiers associated with subscriber identifiers, comprising:
a multi-link authenticator for receiving a link identifier and subscriber identifier from a radio element, receiving a link identifier list associated with the subscriber identifier from the subscriber database, and authenticating the radio element when the link identifier matches a link identifier in the link identifier list.

9. The communication system of claim 8, further comprising:
a plurality of radio elements, each radio element associated with a unique link identifier and a subscriber identifier common to the plurality of radio elements.

10. The communication system of claim 9, further comprising:
a multi-link protocol for aggregating data from and parsing data to the plurality of radio elements.

11. The communication system of claim 8, further comprising:
an Authentication, Authorization and Accounting (AAA) server, the AAA server comprising a subscriber database including records associated with subscriber identifiers, the records comprising one or more link identifiers.

12. The communication system of claim 8, further comprising:
a packet data service node (PDSN) for communicating with the base station using a plurality of interfaces, each interface distinguished by a link identifier associated with one of the plurality of radio elements.

13. A communication system, comprising:
means for receiving a link identifier and a subscriber identifier from a radio element;
means for receiving a link identifier list corresponding to the subscriber identifier from a subscriber database; and
means for authenticating the radio element when the link identifier matches a link identifier in the link identifier list.

14. A communication system, comprising:
means for sending a link identifier and subscriber identifier from each of a plurality of radio elements to a base station, each link identifier unique to a corresponding radio element and the subscriber identifier common to the plurality of radio elements.

15. A communication system, comprising:
means for accessing an AAA server with a subscriber identifier to receive a link identifier list comprising one or more link identifiers associated with the subscriber identifier.

16. A communication system, comprising:
means for authenticating a wireless connection between the base station and one of the plurality of radio elements when a link identifier associated with the radio element matches a link identifier in a link identifier list.

17. The method of claim 16, further comprising:
means for connecting the wireless connection to an access node, the connection distinguished by the link identifier.

18. A base station, operable with a plurality of radio elements and a subscriber database, the subscriber database including lists of link identifiers associated with subscriber identifiers, comprising:
a multi-link authenticator for receiving a link identifier and subscriber identifier from a radio element, receiving a link identifier list associated with the subscriber identifier from the subscriber database, and authenticating the radio element when the link identifier matches a link identifier in the link identifier list.

19. The base station of claim 18, further comprising an accounting means for accumulating network usage information associated with a link identifier and reporting the information with the associated subscriber identifier.

20. A base station, comprising:
means for receiving a link identifier and subscriber identifier from a radio element;
means for receiving a link identifier list associated with the subscriber identifier from a subscriber database; and
means for authenticating the radio element when the link identifier matches a link identifier in the link identifier list.

21. Processor readable media operable to perform the following step:
accessing a subscriber database with a subscriber identifier to receive a link identifier list comprising one or more link identifiers associated with the subscriber identifier.

22. Processor readable media operable to perform the following steps:
receiving a link identifier and subscriber identifier from a radio element;
receiving a link identifier list associated with the subscriber identifier from a subscriber database; and
authenticating the radio element when the link identifier matches a link identifier in the link identifier list.

23. The processor readable media of claim 22, operable to perform the further step of connecting to an access node, the connection distinguished by the link identifier.

24. A mobile station, operable with a base station, comprising:
a plurality of radio elements, each radio element associated with a unique link identifier and a subscriber identifier common to the plurality of radio elements, the link identifier and subscriber identifier transmitted to the base station during initialization of communication therewith.

25. The mobile station of claim 24, further comprising a multi-link protocol for aggregating data from and parsing data to the plurality of radio elements.

26. A mobile station, comprising:
means for transmitting a link identifier and subscriber identifier corresponding to a radio element to a base station for initialization of communication therewith.

27. The mobile station of claim 26, further comprising:
means for aggregating data from and parsing data to a plurality of radio elements.

28. Processor readable media operable to perform the following step:
sending a link identifier and subscriber identifier from each of the plurality of radio elements to a base station, each link identifier unique to a corresponding radio element and the subscriber identifier common to the plurality of radio elements.

29. An Authorization, Authentication, and Accounting (AAA) server, comprising:
a database of records, each record associated with a subscriber identifier, each record comprising one or more link identifiers.

30. The AAA server of claim 29, operable to receive an access request with a subscriber identifier from a base station and to transmit information from the record corresponding thereto.

31. An Authorization, Authentication, and Accounting (AAA) server, comprising:
means for associating a subscriber identifier with a record comprising one or more link identifiers.
